(19) United States
(12) Patent Application Publication
(10) Pub. No.: US 2019/0065692 A1
(43) Pub. Date: Feb. 28, 2019

(54) Method and System for Determining Individualized Heath Scores

(71) Applicant: Patrick Michael Connelly, San Francisco, CA (US)

(72) Inventor: Patrick Michael Connelly, San Francisco, CA (US)

(21) Appl. No.: 15/692,078

(22) Filed: Aug. 31, 2017

(51) Int. Cl. G06F 19/00

(52) U.S. Cl. CPC G06F 19/3431; G06F 19/3475; G06F 19/36; G06F 19/322

(57) ABSTRACT

A method and system for creating objective health scores for an individual, based on normalized, aggregate data. The system creates the scores abased on user input, as well as on data collected from third party sources. The third party sources include wearable fitness trackers, sources that provide information on sleep patterns, and further include information relating to financial transactions. The financial transaction information provides the system with information about the user's food purchases. The system categorizes the data into categories and subcategories, normalizes it against a normalized distribution model, and calculates health scores for the user's fitness, nutrition and sleep, as well as an aggregate, or universal, health score.

### FIELD OF THE INVENTION

The present invention relates to medical, health and nutrition data and more particularly, to a method for creating a real-time health score based on user information, which may be used by medical insurance companies and for personal use including to facilitate a greater personal health understanding.

### BACKGROUND OF THE INVENTION

Many Americans struggle with issues relating to health and healthcare. For example, it can be difficult to have a proper and up to date understanding of nutrition, exercise habits and proper sleep practices. Scientific studies are routinely contradictory or overstated. The movement of health data is moving faster than consumers can keep up with. For example, the base nutrition philosophy of the early 1990's, The Food Pyramid, has been shattered and replaced with the “Farm to Table” movement. At the same time, health care costs are rising. As a result, it is more important than ever for people to be able to maintain healthy habits.

In general, the volume of data relating to personal habits, including habits that impact health, has exploded. For example, today, 1 in 5 Americans own a wearable device that tracks activity such as steps taken in a day and miles walked. Some wearable devices also track nutritional intake and other health related information. The popularity of such devices is growing, and the ability to track real-time health events in our lives is only at its infancy.

Current health event data is not actionable in that all available data relating to health events is not correlated and there are no objective indicia for determining a health score for an individual. True correlation and relationships of individual health inputs remains unknown. The importance of the relationships between data and of an overall health score is not only scientifically significant but influences daily personal experiences and health care costs.

Currently, although there are numerous systems in the art that allow individuals to gather data relating to health, that data is isolated from other relevant health information, and does not provide the user with an overall, objective measure of health. Furthermore, there is no method or system in the art for analyzing that data objectively such that a user can obtain an overall health score. Insurance companies can use the health score to reduce insurance premiums of individuals with a favorable health score. Individuals can use that data as a basis for creating a healthy lifestyle.

The present invention provides a means for inputting, analyzing, and correlating health data to improve individual health quality. The present invention creates measureable health metric(s) that include universal health scoring for consumer. The result is consistent data inputs for big data and enterprise analysis.

The goals of the present invention are achieved through the use of a specialized computer system as described herein. The computer system obtains data from third party sources, analyzes and correlates the data, and stores it in a cloud-based database.

### BRIEF DESCRIPTION OF THE DRAWINGS

FIG. 1 depicts the manner in which the specialized computing system gathers and analyzes data in order to calculate an individual health score based on normalized data.

FIG. 2 shows the manner in which the specialized computer creates a user profile, and correlates profile data against normalized health data to create an individual score.

FIG. 3 depicts the manner in which a health score is calculated by the specialized computer.

FIG. 4 depicts the system architecture of the present invention.

### DETAILED DESCRIPTION OF THE INVENTION

The system of the present invention includes a real time health scoring software layer that sits on top of any event health data stream. The health-scoring layer gathers and processes the health data stream in real time, and interfaces with a health event data stream as well as global, non-personalized data, to create and update an individual health score. This allows consumers to understand the key health factors that influence their daily health without manual input, while avoiding unintentional data influence that can occur with manual input. The result is actionable health data. The result also has the benefit of being efficient and not requiring the time of the individual to input data or manually create a score.

The system of the present invention provides a health scoring model achieved via a specialized computer, with emphasis on the first party nutrition model that includes input, categorization, correlation, scoring and user profiling of financial transaction data creating an automated health understanding experience for users.

The system of the present invention utilizes a specialized computer that includes a cloud-computing component. The system imports data from user fitness trackers and merges that data with financial data in order to track fitness and food purchase events data. The system adds event scoring and output on top of that for easy to understand daily health scores, and displays the data in real time to web and mobile device such as smartphone, tablet, and smart watches.

The specificity and classification of the health data creates systematic and personalized health recommendation opportunities that can sit on top of any data set, or API feed. The system data structure includes:
Scientific identification of key health inputs
Categorization of health inputs
Correlation of health inputs
Analytics associated with the health data
User goals
Personalized event tracking of goal progress
Real time mobile delivery to consumers

The invention described herein includes a method for collecting, categorizing and scoring electronic health tracking data by analyzing and executing the following steps on a specialized processor and displaying them on a digital user interface such as a smart phone or a web page.

The system and method of the present invention may be used by individuals and may also be used by entities such as medical insurance companies or other medical providers.

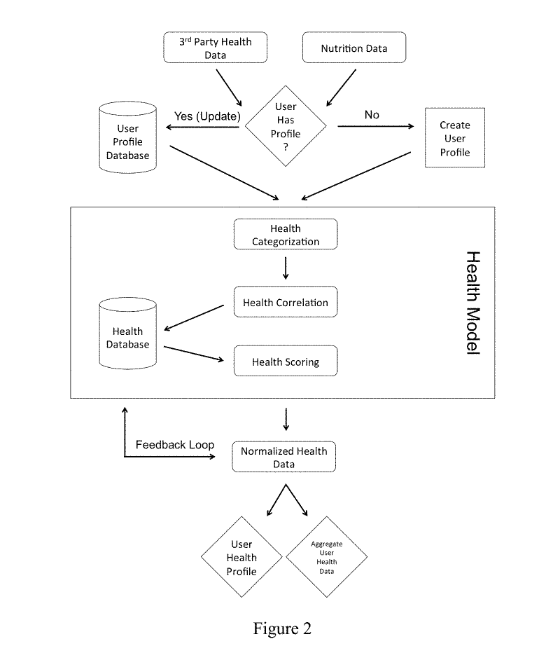

User Profile. The present invention includes a user profile. FIG. 2 depicts the manner in which the user profile is created. As shown, the system creates the user profile by prompting the user for information including their email address. In particular the system is capable of interfacing with any personal electronic device, such as a personal computer, smartphone, tablet, and smart watches, and gathering input data through the web. Once the user inputs profile information, the system also requests permission from the user to access their social media profiles on third party websites or mobile applications. The system further generates a unique user ID, which is provided to the user. The system stores the ID as a unique identifier, and associates all data relating to the user with that ID. The system prompts the user to create a unique password, which will be required for future logins.

The system likewise creates a user data file based on information input by the user and gathered from third party websites and apps. That user file is then stored in a database in the cloud. Information in the user file includes the user's age and/or birthdate, gender physical address, and birthplace. As described herein, the system obtains health-related data in real-time, correlates that data with information in the user's profile, and uses it to generate an objective health score, based on normalized data.

Information that the system gathers and correlates with the unique user file includes information obtained from wearable or carryable fitness trackers, sleep data, and financial data. The system scans third party databases in real time in order to obtain that information either through publically accessible APIs. The system can also update the user's file with data input directly from the user. Regarding third party databases, users allow access to those databases digitally connecting their individual username/password to those databases on signing up for the system.

The final Step of compiling user profile is adding nutrition-related data from financial transactions. When the user signs up for the system, he or she provides direct access to private financial account information by digitally connecting their individual username and password for all available financial institutions to the system of the present invention. Information gathered from financial transactions includes information relating to where food purchases are made. Based on the location and amount of purchase, the system is able to obtain information relating to the nutritional intake of the user. The process of categorizing financial transactions data to food and nutrition purchases is described more fully below.

Financial data is used to inform the system as to what types of food purchases the user is making, including the source of the purchase. That information can inform the system, for example, as to whether the food purchase is likely to be high in sodium and saturated fats, or whether it is likely to consist of organic or heart healthy ingredients.

The system accesses the user's social media platforms, third party health and fitness tracking software, applications and wearable devices and financial institution debit and credit card data on an ongoing basis. The system collects the data via a processor. The processor can be triggered to gather new data when a user engages the digital electronic interface and adds new health events. Alternatively, the processor can be alerted to new health related data by third party APIs. Third party data including exercise, sleep and nutrition (provided by credit card purchase logging) are pushed upon event completion to provide as close to real-time updates as technically available through third party pings to the system and pulled hourly, even when the user is passive (or not logged in), through the same third party data sources to provide a complete interactive health score. This data is synced with the existing user profile data and user input health events to create a user data profile that is updated in real time to output health event details and scores that are stored on cloud storage devices and sorted by existing user profile identifiers. This health event data is pulled from cloud storage devices and displayed on user interfaces including web and mobile device such as smartphone, tablet, and smart watches.

The system stores the user profile information in cloud based storage server database system and called for digital display in web and mobile device such as smartphone, tablet, and smart watches using hosted web services to display real-time health data for users.

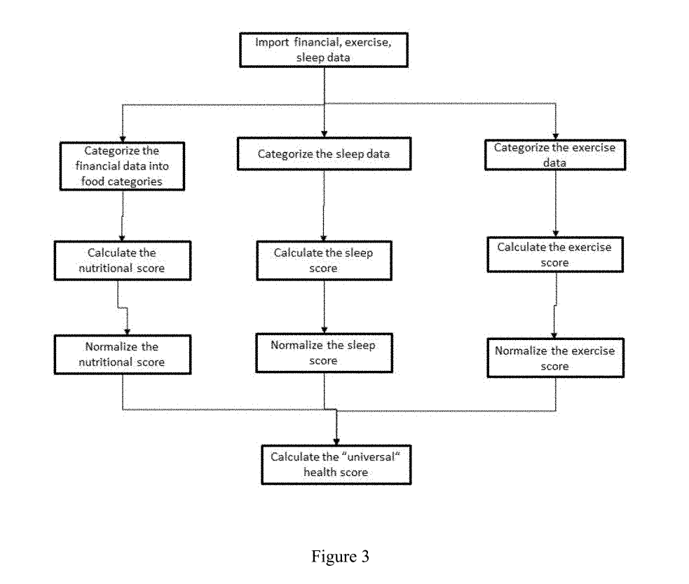

FIG. 3 depicts the manner in which the third party data is imported into the cloud based system. All data, both from third party systems and user input is categorized and scored for both the user and the aggregate universe of data. Both the raw event and scored data is stored in the cloud-based systems. Uploaded and stored data is unique to the user and tagged based on user ID to create a unique identifier of the event, score and categorization. This allows the data to be compared against additional stored user data, user groups and aggregate data. The imported data are categorized into three categories: nutrition, exercise and sleep. The data is further categorized into subcategories useful for heath calculations for nutrition, exercise and sleep. Then the system performs data correlation on the data. The nutrition, exercise and sleep data are then run through health scoring model and calculated. Nutrition, exercise and sleep scores are normalized using a normalized distribution model and then a universal health score is calculated. Finally, the health scores for nutrition, exercise and sleep are stored with the user profile along with the universal health score.

Categorization. After ingesting the data stored in the third party databases for a particular user, data must be categorized for analysis. Categorization occurs across three pre-determined set categories: Nutrition, Exercise and Sleep.

Nutrition data is only collected from financial institution debit and credit card transaction data. Categorization of nutrition data is sorted to the following data:
Food Category—grouping of food transaction data including: Grocery Stores, Coffee Shops, Fast Food and Restaurants.
Amount Spent—total spend per transaction
Description—details of individual food transaction including itemized receipt information per Food Category
Time—time of transaction
Location—Address, Zip Code, Country

The data structure for the nutrition data for the software system is:

Nutrition_entries (
Datetime,
Category_type,
Simple_desc,
Orig_desc,
Amount,
currency
)

All nutrition data except for the food categories are sourced and imported from financial institution debit and credit card transaction data. No refinements or categorizations are made at this step.

Food categories are created using additional mapping resources. After ingestion of user financial transactions, data is parsed to isolate all “Food” category purchases. All non-food category purchases are ignored and are not imported. Food category purchases are then subcategorized using third party API categorizations. Examples of these subcategories are: Fast Food, Groceries, Coffee, and Restaurant Chains. The mapping of the food purchases into food subcategories is needed in order to put a health score to the food purchase. This is accomplished by mapping the financial purchase service establishments with sub-categories. Any non-categorized purchases are removed from the system as well.

Exercise and sleep data is collected from all user authorized and connected third party health & fitness tracking software, applications and wearable devices. Categorization of Sleep data is limited to the following data:
Sleep Time—total time asleep,
Total Rest Time—sleep time & rest time,
Time—time stamp of event, including start and finish,
Location—Address, Zip Code, Country, and
Weather—current weather at location

The data structure for the sleep data for the software system is:

Sleep_entries (
Datetime,
Minutes_in_bed,
Minutes_asleep
)

Categorization of exercise data is limited to the following subcategories:
Activity Type—activity data categorization including: Walk, Bike Ride, Run, Swim, Hike, AlpineSki, Backcountry Ski, Canoeing, Crossfit, Elliptical, IceSkate, InLine Skate, Kayaking, Kitesurf, NordicSki, Rock Climbing, RollerSki, Rowing, Snowboard, Showshoe, StairStepper, StandupPaddle, Surfing, VirtualRide, WeightTraining, Windsurf, Workout, Yoga, Team Sports, Golf, Meditation, Therapy, SoulCycle, Barry's BootCamp, Orange Theory, Peloton, Flywheel, Pilates, Bar Method, HIIT, TRX and custom user inputs. These activity types are only sample and can be adjusted, as the software system is refined and new exercise habits are defined or request by users.
Duration—total time of event,
Distance—total distance including steps, miles, elevation change, GPS coordinates, and
Time—time stamp of event, including start and finish

The data structure of the exercise data for the software system is:

Exercise_entries (
Datetime,
Steps,
Minutes_sedentary
Minutes_lightly_active
Minutes_fairly_active
Minutes_very_active
)

All data is parsed through a cloud-based server into the “health model” and stored in the health database linking the health data with the corresponding user profile. Data that is not available or not available for categorization is ignored but continues to be stored in user health profile for aggregate health model and data correlation. FIG. 2 shows how the data associated with the user is process through the software system and linked with the user profile.

### Correlation

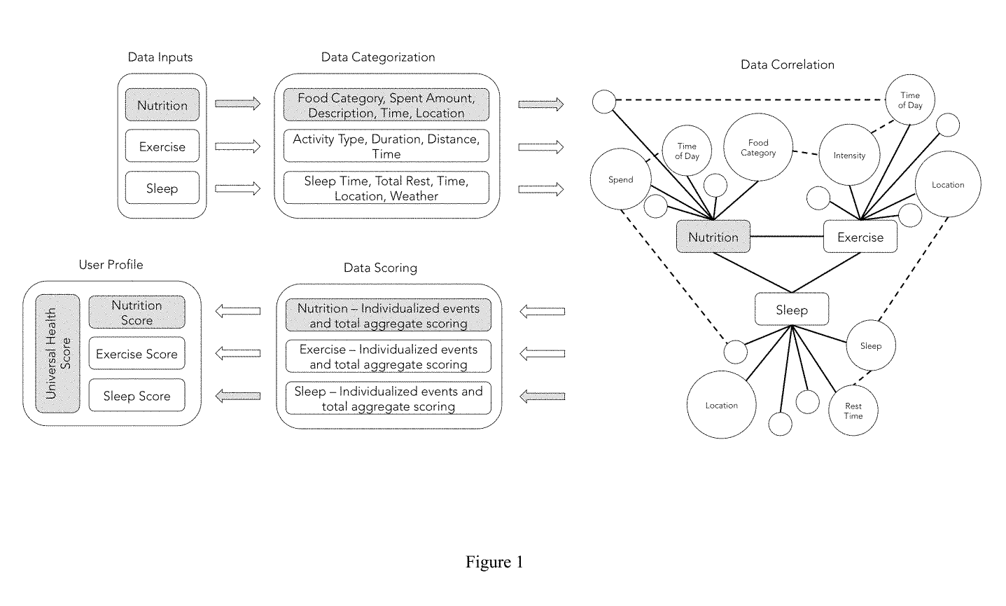

All category level relationships are assumed positive. Subcategory relationships are stated as: Positive, Neutral or Negative. The strength of that relationship is scaled from −100 to 100. −100 being the lowest and 100 being the highest. Relationships are non-reciprocal and move in one direction as shown in FIG. 1. A subcategory can be influenced by subcategory in one direction and also influence the same subcategory in a different unique way from the other direction of input. So that, positive relationships in one direction, can we negative or neutral relationships in the other (reciprocal) direction.

Correlations of subcategories are created at individual user level and can differ from one unique user ID to the next. Correlations are assigned to unique user ID and stored in user profile database.

### Relationship Strength

Subcategory relationship strength is created based on individual subcategory influence of the daily individual category score.

It is expected that over time individual subcategories will be solely represented at the influence of the category score to ensure that all subcategories have relationship score to their overarching category.

A subcategory relationship strength score is calculated by calling the back the processed category score from the health model and calculating the increase or decrease the subcategory had when present for both its hierarchical category and all other categories. The percent change determines the strength (positive, neutral or negative) of the relationship with all other subcategories that were present in the calculation. Subcategories that are not present are ignored.

The percent change is then converted to a −100 to 100 score that represents the relationship of the strength (positive, negative or neutral) of the two subcategories.

Correlation data is sent to the user profile data for storage via each individual unique user ID and sent to the data model feedback to update the health model.

### Data Scoring

Data scoring is processed using a hierarchical scoring model that starts with individual scorings that builds to aggregate model scoring—at both the individual and aggregated level.

Individuals are scored by combing the cumulative score of each subcategory to create a category score. The 3 categories are added to create the final individual “universal” health score. This process allows normalization of exercise, nutrition, and sleep categories into a single “universal” health score. This normalization of health data creates a unique and universal health model that will allow for homogenized data for both internal and external data sets, creating a standard measurement and formula for health data.

Individual Category Scoring are calculated by taking the regular inputs (from user authorized and connected 3rd party health & fitness tracking software, applications and wearable devices and financial institution debit and credit card data).

Exercise score is calculated by taking the daily inputs of steps and activity and using the following mathematical formula:
Activity Score is calculated based on the category types listed above (Walk, Bike Ride, Run, Swim, Hike . . . ) with a weighted score from 0-2. The higher the score the higher the health correlation. Example weights are 2 for a “surfing” activity type and 1 for “walking” activity type.

Total Activity Score=(Total Daily Steps or Total Time Per Activity)* (1+((activity score 1+activity score 2+ . . . )/(Total activity)).
For activities with measurement other than steps use:
   Steps=2,112 Steps to 1 Mile
For activates without distance use time per activity:

Total Time per activity (Minutes)*10,000 (Note: Max total per single user event=10,000)

Activity scores has been setup in the software system manually. For example, walking/hiking would have activity score of 1 while running would have an activity score of 2. These activity score indicate the intensity of the workout. So, the walking activity score would be lower than running and biking. The total activity intensity score would be calculated by counting the total daily steps multiplied by each activity scores performed and divided by the total activity. The activity score is calculated from cumulative exercise data over for the current day. These activity scores are only example scores. These activity scores can be adjusted as the software system gets refined. Table 1 shows a sample data associated with the walking activity.

| | | | Minutes | |
|---|---|---|---|---|
| Data | Steps | Distance | Sedentary | Activity |
| 6/25 | 6,946 | 3.13 | 729 | Walking |
| 6/26 | 5,094 | 2.3 | 810 | Walking |
| 6/27 | 6,837 | 3.08 | 755 | Walking |
| 6/28 | 9,450 | 4.26 | 606 | Walking |
| 6/29 | 1,815 | 0.82 | 794 | Walking |
| 6/30 | 3,031 | 1.37 | 963 | Walking |
| 7/1 | 10,309 | 4.65 | 664 | Walking |
| 7/2 | 7,368 | 3.37 | 513 | Walking |

Table 1 shows a typical data for walking activity

Sleep score is calculated by taking the total sleep time and total rest time (time bed) and using the following mathematical formula:

Total Sleep Score=sleep duration*(1+((total rest−sleep duration)/total rest))

The total rest time is the time that the user is in bed. The sleep duration is the amount of time that a person was sleep in bed. The sleep score is calculated by the sleep duration multiplied by total rest subtracted by sleep duration and divided by total rest for the current day. Table 2 shows some of the typical numbers generated by the sleep calculations.

| | Minutes | Minutes | Number of | Time in | |
|---|---|---|---|---|---|
| Date | Asleep | Awake | Awakenings | Bed | Sleep Total |
| 6/25 | 491 | 34 | 20 | 526 | 523.671103 |
| 6/26 | 516 | 25 | 15 | 541 | 539.844732 |
| 6/27 | 528 | 28 | 9 | 560 | 558.171429 |
| 6/28 | 471 | 12 | 8 | 483 | 482.701863 |
| 6/29 | 540 | 40 | 20 | 580 | 577.241379 |
| 7/1 | 750 | 16 | 7 | 766 | 765.665796 |
| 7/2 | 559 | 37 | 17 | 596 | 593.70302 |

Table 2 shows sleep calculations.

Nutrition score is calculate by taking category scores and description scores and using the following mathematical formula:

Food Category Score: Restaurants/Dining=1, Groceries=2,

Food Description Score: Fast Food=−3; Groceries: 4; Coffee=1; Restaurant Chains=1; Bars=−1; Other=1,

Total Food Score=(category score 2* Description Score 2)+(category score 2* Description Score 2)+ . . . )/(Total Daily Events)

Food category score are defined in the system. The food category score is set based on how healthy the food category is. Food category is divided into dining and groceries. Since groceries are healthier than dining out, it has high food category score. Also, food description score are scored based on how healthy the food transaction is. For example fast food has food description score of −3, which is much lower than groceries, which has the score of 4. Note that food category score and food description scores are only sample scores and can be adjusted as the software system is refined. To calculate the total food score, food category score is multiplied by the food description score for all food transactions and divided by the total daily number of food events for the current day. Table 3 shows a sample list of foods and corresponding calculations.

| | | | | | | Total | Daily | |
|---|---|---|---|---|---|---|---|---|
| | | Category | Category | Descript. | Descript. | Event | Total | Avg. |
| Date | Data Event | Input | Score | Input | Score | Score | Score | Daily |
| 7/22 | Starbucks | Dining | 1 | Coffee | 1 | 1 | 10 | 3.3333 |
| | Whole Foods | Groceries | 2 | Groceries | 4 | 8 | | |
| | Starbucks | Dining | 1 | Coffee | 1 | 1 | | |
| 7/23 | McDonalds | Dining | 1 | Fast Food | −3 | −3 | −2 | −1 |
| | Starbucks | Dining | 1 | Coffee | 1 | 1 | | |
| 7/24 | Starbucks | Dining | 1 | Coffee | 1 | 1 | 4 | 1.3333 |
| | Chipotle | Dinning | 2 | Restaurant | 1 | 2 | | |
| | Starbucks | Dining | 1 | Coffee | 1 | 1 | | |

Table 3 shows the nutritional information calculation.

Once raw categories scores are calculated into exercise, nutrition and sleep scores, they are input into a normalized distribution model (e.g., standard bell curve)

$$f ( x \vert μ , {σ}^{2} ) = \frac{1}{\sqrt{2 {σ}^{2} π}} {e}^{- \frac{{( x - μ )}^{2}}{2 {σ}^{2}}}$$

The mean and standard deviation are set static variables that allow for multiple data points at one single variance on the distribution model, so that, each individual is compared against the typical outcome and not weighted against each other's score. The health score for an individual is compared with the rest of the people in the system by putting everyone into a normalized distribution model and seeing where that individual places itself in the normalized distribution model. This normal distribution calculation normalizes each exercise, food and sleep scores. Mean and Standard deviations are unique to each exercise, food and sleep categories. A individual can be put into a separate normalized distribution model based on age, sex, geographic location, etc.

Categories scores of exercise, food and sleep ranges from 0.01 to 1.00 and are multiplied by 100 to create a final score of 1-100.

Aggregate “universal” score are the addition of each category score divided by 3 to get a total score of 1-100. Each category of exercise, food and sleep are weighted equally. In other words, each category of food, health and sleep categories have equal contribution to the final health score. The “universal” health score and the nutrition, exercise, and sleep category scores are linked to the user profile.

Software system keeps track of universal health scores as well as nutrition, exercise, and sleep scores are stored for a day, a week, a month, 6 months and 1-year aggregates. This data is re-analyzed every the system imports new data for a user of the system. The system merges new health data with the historical data and calculates personal health trend based on the person's past health scores.

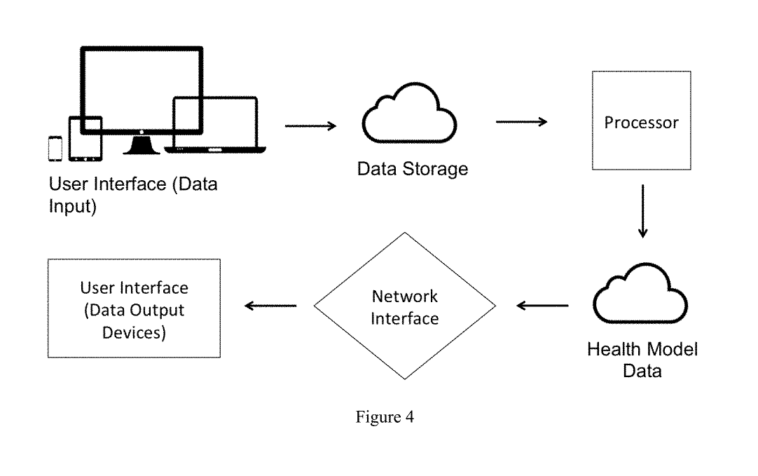

FIG. 4 shows the system architecture and the manner in which the data is process through the software system. The input data such as fitness trackers, food transaction histories, and sleep monitors are used to input the data into the software system. The system uses computer processor to categorize and calculate health scores and associate with user profiles and store this information in the health data model. Health scores are then displayed through the output user interfaces such as smart phone, smart watch, tablet or web browser.

Health scores are processed in the cloud service server database when new data is ingested from 3rd party health and fitness tracking software, applications and wearable devices and financial institution debit and credit card data as shown in FIG. 1. This occurs at regular daily intervals (by the hour, every 4 hours or daily), when a user engages the digital electronic interface, or when notified of new data by third party APIs. Health score is displayed to the user through a smart phone, smart watch, tablet and or web page. The bubbles depicted in FIG. 1 illustrate additional input fields who that can be added to influence the health score. Examples include time that the user is asleep as compared to time the user is in bed, or time the user spends in REM Sleep as compared to time spent in Normal Sleep for the sleep score.

All examples and conditional language recited herein are intended for educational purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents hereof. Additionally, it is intended that such equivalents include both currently known equivalents as well as equivalents developed in the future, i.e., any elements developed that perform the same function, regardless of structure.

1. A system for calculating at least one user health score including:
a user interface;
a cloud-based data storage system for storing and updating user data;
a specialized processor programmed to obtain data from third party APIs, to sync that data with existing data and to calculate at least one health score.

2. The system of claim 1 wherein the specialized processor obtains data from said third party APIs when it receives alerts of a data event from said third party API.

3. The system of claim 1 wherein said specialized processor obtains data from said third party APIs by conducting scans of said third party APIs on regularly scheduled intervals and further comparing said data against existing data to identify new data.

4. The system of claim 1 wherein said third party APIs include those of financial institutions.

5. The system of claim 1 wherein said third party APIs include those of wearable fitness trackers.

6. The system of claim 1 wherein said health score is a fitness health score.

7. The system of claim 1 wherein said health score is a nutrition health score.

8. The system of claim 1 wherein said health score is a sleep score.

9. The system of claim 1 wherein said health score is an aggregate health score.

10. A method for calculating an individual health score comprising the steps of:
creating a user account;
creating a cloud-based storage system linked to said user account;
a user interface to input first party users health data related to fitness, sleep and nutrition events;
linking said user account to third party APIs which contain information relating to the user's fitness activities;
linking said user account to the user's banking accounts;
obtaining the user's fitness data from said third party APIs;
obtaining data relating the user's food purchases from said user's banking accounts;
storing said fitness data and said food purchase data in said cloud-based storage system;
categorizing said stored fitness data and said food purchase data;
correlating said categorized data to a health scoring model; and
calculating at least one health score for the user.

11. The method of claim 8 where said at least one health score is a fitness score.

12. The method of claim 8 where said at least one health score is a nutrition score.

13. The method of claim 8 where said at least one health score is a sleep score.

14. The method of claim 8 where said at least one health score is an aggregate health score.

15. The method of claim 8 wherein said stored fitness data and said food purchase data is categorized into the categories of nutrition, exercise and sleep.

16. The method of claim 9 wherein said categorized data is further categorized into subcategories.

17. The method of claim 8 wherein said categorized data is normalized using a normalized distribution model.

18. The method of claim 8 wherein said health score is stored with the user profile.
